(19) United States
(12) Patent Application Publication
(10) Pub. No.: US 2026/0106203 A1
(43) Pub. Date: Apr. 16, 2026

(54) WINDING DEVICE FOR SECONDARY BATTERIES

(71) Applicant: SAMSUNG SDI CO., LTD., Yongin-si (KR)

(72) Inventor: Kyeong Yun PARK, Yongin-si (KR)

(21) Appl. No.: 19/220,366

(22) Filed: May 28, 2025

(30) Foreign Application Priority Data
Oct. 16, 2024 (KR) 10-2024-0141064

(51) Int. Cl. H01M 10/04

(52) U.S. Cl. CPC H01M 10/0409

(57) ABSTRACT

Embodiments provide a winding device for a secondary battery that is capable of improving electrical stability of the secondary battery. The winding device includes a core including a flat portion and an inclined portion, the core configured to wind an electrode assembly of the secondary battery, an antistatic part disposed on the flat portion, wherein static electricity is prevented from being generated between the core and the electrode assembly.

### CROSS-REFERENCE TO THE RELATED APPLICATION

The present application claims priority to and the benefit under 35 U.S.C. § 119(a)-(d) of Korean Patent Application No. 10-2024-0141064, filed in the Korean Intellectual Property Office on Oct. 16, 2024, the entire disclosure of which is incorporated herein by reference.

### BACKGROUND

### 1. Field

The present disclosure relates to a winding device for a secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Embodiments of the present disclosure provide a winding device for a secondary battery, which is capable of solving a limitation of an unstable shape of an electrode assembly if a core is separated from the electrode assembly of the secondary battery.

Embodiments of the present disclosure provide a winding device for a secondary battery, which is capable of reducing winding defects in an electrode assembly.

However, the technical problems to be achieved in the embodiment of the disclosure are not limited to the technical problems mentioned above, and other technical problems not mentioned herein will be clearly understood from the following description by those skilled in the art to which the disclosure belongs.

According to some embodiments, a winding device for a secondary battery includes: a core configured to wind an electrode assembly including a positive electrode plate, a negative electrode plate, and a separator and provided with a flat portion and an inclined portion; and an antistatic part installed on the flat portion to prevent static electricity from being generated between the core and the electrode assembly.

Embodiments of the present disclosure provide a winding device for a secondary battery, including: a core comprising a flat portion and an inclined portion, the core configured to wind an electrode assembly, the electrode assembly comprising a positive electrode plate, a negative electrode plate, and a separator; and an antistatic part disposed on the flat portion, wherein static electricity is prevented from being generated between the core and the electrode assembly.

In some embodiments, the core may include: a first core extending in a longitudinal direction; and a second core disposed to face the first core and extending in the longitudinal direction.

In some embodiments, the core includes: a first core extending in a longitudinal direction; and a second core extending in the longitudinal direction and facing the first core.

In some embodiments, the first core may include: a first front surface configured to define a plane at an upper side of the first core; a first rear surface installed in parallel to the first font surface and configured to define a plane at a lower side of the first core; a first inclined portion having a wedge shape and configured to connect the first front surface to one side of the first rear surface in a width direction; and a first side portion configured to connect the first front surface to the other side of the first rear surface in the width direction.

In some embodiments, the first core includes: a first front surface defining a plane at an upper side of the first core; a first rear surface defining a plane at a lower side of the first core; a first inclined portion connecting the first front surface to one side of the first rear surface in a lateral direction; and a first side portion connecting the first front surface to the other side of the first rear surface in the lateral direction.

In some embodiments, the second core may include: a second front surface configured to define a plane at an upper side of the second core; a second rear surface installed in parallel to the second font surface and configured to define a plane at a lower side of the second core; a second inclined portion having a wedge shape and configured to connect the second front surface to one side of the second rear surface in a width direction; and a second side portion configured to connect the second front surface to the other side of the second rear surface in the width direction.

In some embodiments, the second core includes: a second front surface defining a plane at an upper side of the second core; a second rear surface defining a plane at a lower side of the second core; a second inclined portion connecting the second front surface to one side of the second rear surface in a lateral direction; and a second side portion connecting the second front surface to the other side of the second rear surface in the lateral direction.

In some embodiments, the antistatic part may be installed on at least one of the first front surface and the first rear surface or the second front surface and the second rear surface.

In some embodiments, the antistatic part is disposed on at least one selected from the first front surface, the first rear surface, the second front surface, and the second rear surface.

In some embodiments, the antistatic part may be installed on the first front surface and the first rear surface, and the second front surface and the second rear surface.

In some embodiments, the antistatic part is disposed on the first front surface, the first rear surface, the second front surface, and the second rear surface.

In some embodiments, the antistatic part may include a tape attached to the outside of the core and be installed on each of planes provided on front and rear surfaces of the core.

In some embodiments, the antistatic part comprises a tape attached to an exterior of the core and is disposed on each of planes on front and/or rear surfaces of the core.

In some embodiments, the antistatic part may extend in a longitudinal direction of the core and has a rectangular shape.

In some embodiments, the antistatic part extends in a longitudinal direction of the core and has a substantially rectangular geometry.

In some embodiments, in the antistatic part, at least one edge of edges in the rectangular shape may be curved.

In some embodiments, in the antistatic part, at least one edge of edges in the substantially rectangular geometry is curved.

In some embodiments, the antistatic part may include: an antistatic layer including Teflon; and an adhesive layer configured to fix the antistatic layer to the core.

In some embodiments, the antistatic part includes: an antistatic layer including a fluoropolymer; and an adhesive layer configured to fix the antistatic layer to the core.

In some embodiments, the antistatic layer may be provided by mixing nanomaterials into Teflon.

In some embodiments, nanomaterials are mixed into the fluoropolymer.

According to some embodiments, a winding device for a secondary battery may include: a core configured to wind an electrode assembly including a positive electrode plate, a negative electrode plate, and a separator and provided with a flat portion and an inclined portion; a coating layer applied to the outside of the core to prevent static electricity from being generated; and an antistatic part adhering or fixed to the outside of the coating layer in the form of a tape and configured to static electricity from being generated between the core and the electrode assembly.

Embodiments of the present disclosure provide a winding device for a secondary battery, including: a core including a flat portion and an inclined portion, the core configured to wind an electrode assembly, the electrode assembly including a positive electrode plate, a negative electrode plate, and a separator; a coating layer applied to an exterior of the core; and an antistatic part applied to the exterior of the coating layer, wherein static electricity is prevented from being generated between the core and the electrode assembly In some embodiments, the antistatic part may extend in a longitudinal direction of the core and has a rectangular shape.

In some embodiments, the antistatic part extends in a longitudinal direction of the core and has a substantially rectangular geometry.

In some embodiments, in the antistatic part, at least one edge of edges in the rectangular shape may be curved.

In some embodiments, in the antistatic part, at least one edge of edges in the substantially rectangular geometry is curved.

In some embodiments, the antistatic part may include: an antistatic layer including Teflon; and an adhesive layer configured to fix the antistatic layer to the core.

In some embodiments, the antistatic part includes: an antistatic layer including a fluoropolymer; and an adhesive layer configured to fix the antistatic layer to the core.

In some embodiments, the antistatic layer may include: a conductive layer continuously stacked on the adhesive layer and configured to prevent static electricity accumulation and disperse charges; an insulating layer continuously stacked the conductive layer and configured to provide electrical insulation; and an antistatic layer stacked on the outside of the insulating layer and configured to prevent static electricity from being generated.

In some embodiments, the antistatic layer includes: a conductive layer disposed on and in contact with the adhesive layer, the conductive layer; an insulating layer disposed on and in contact with the conductive layer; and an antistatic layer disposed on and in contact with an exterior of the insulating layer.

In some embodiments, the conductive layer may include at least one of silver nanoparticles, graphene, or carbon nanotubes.

In some embodiments, the conductive layer includes silver nanoparticles, graphene, or carbon nanotubes.

In some embodiments, the insulating layer may include at least one of Teflon, polyimide, or silicone rubber.

In some embodiments, the insulating layer includes a fluoropolymer, a polyimide, or a silicone rubber.

In some embodiments, the antistatic layer may include at least one of polymer-based antistatic agents (antistatic polymers), conductive polymers, or metal oxide nanoparticles.

In some embodiments, the antistatic layer includes a polymer-based antistatic agent, a conductive polymer, or metal oxide nanoparticles.

In some embodiments, an embossing or grid pattern may be disposed on a surface of the antistatic part to reduce a contact area between the antistatic part and the electrode assembly.

In some embodiments, an embossing or grid pattern is disposed on a surface of the antistatic part.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a schematic view of an apparatus for manufacturing an electrode assembly according to embodiments of the present disclosure;

FIG. 2 is a plan view of a winding device for a secondary battery according to embodiments of the present disclosure;

FIG. 3 is a plan view showing a core and an electrode assembly separated from each other according to embodiments of the present disclosure;

FIG. 4 is a side view of the core and an antistatic part according to embodiments of the present disclosure;

FIG. 5 is a plan view of the core and the antistatic part according to embodiments of the present disclosure;

FIG. 6 is a plan view showing a curved portion provided on the antistatic part according to embodiments of the present disclosure;

FIG. 7 is a cross-sectional view showing the antistatic part installed outside the core according to embodiments of the present disclosure;

FIG. 8 is a cross-sectional view showing a coating layer disposed between the core and the antistatic part according to embodiments of the present disclosure;

FIG. 9 shows an antistatic part according to embodiments of the present disclosure;

FIG. 10 shows an antistatic part according to embodiments of the present disclosure;

FIG. 11 shows an electrode assembly wound by a winding device for a secondary battery according to embodiments of the present disclosure;

FIGS. 12A and 12B are perspective views of a battery pack including a secondary battery according to embodiments of the present disclosure; and

FIG. 13A is a perspective view showing a vehicle including a battery pack including a secondary battery according to embodiments of the present disclosure. FIG. 13B is a side view showing a vehicle including a battery pack including a secondary battery according to embodiments of the present disclosure.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

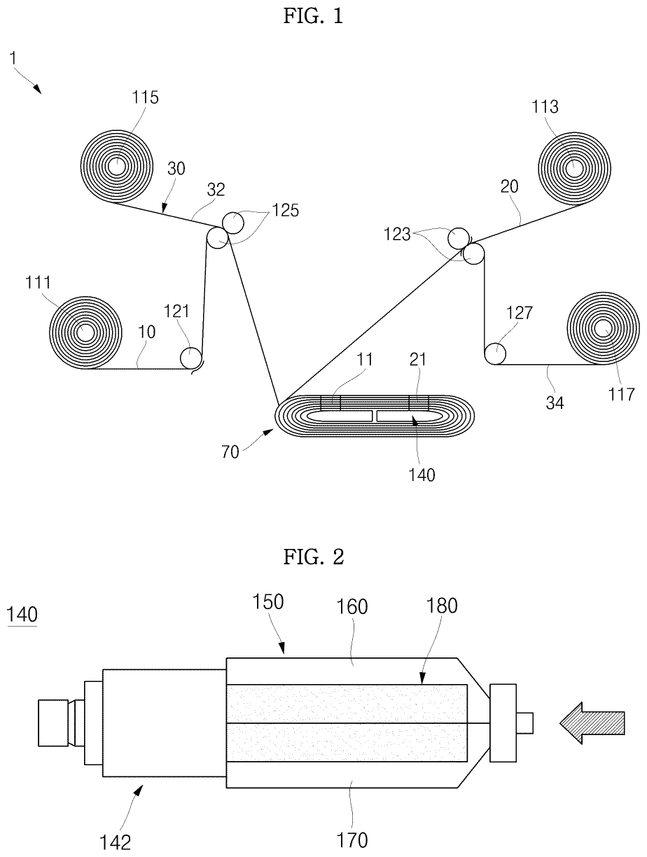

FIG. 1 is a schematic view of an apparatus 1 for manufacturing an electrode assembly according to embodiments of the present disclosure. The apparatus 1 may include a first supply unit 111, a second supply unit 113, a third supply unit 115, and a fourth supply unit 117, a plurality of transfer rollers 121, 123, 125, and 127, and a winding device 140.

In some embodiments, the first supply unit 111 may supply a wound positive electrode plate 10, the second supply unit 113 may supply a wound negative electrode plate 20, the third supply unit 115 may supply a wound first separator 32, and the fourth supply unit 117 may supply a wound second separator 34. The separator 30 used in the electrode assembly 70 may include a first separator 32 and a second separator 34.

The positive electrode plate 10 may be coated with a positive electrode active material on both surfaces and may include a non-coating portion that is not coated with the positive electrode active material and a positive electrode base material tab 11. The negative electrode plate 20 may be coated with a negative electrode active material on both surfaces and may include a non-coating portion that is not coated with the negative electrode active material and a negative electrode base material tab 21. The positive electrode base material tab 11 and the negative electrode base material tab 21 may be provided to protrude at regular intervals from sides of the positive electrode plate 10 and the negative electrode plate 20, respectively. Each of the first separator 32 and the second separator 34 may be interposed between the positive electrode plate 10 and the negative electrode plate 20 to prevent short circuit between the positive electrode plate 10 and the negative electrode plate 20. In this manner, a width of each of the first separator 32 and the second separator 34 may be greater than a width of each of the positive electrode plate 10 and the negative electrode plate 20.

The first to fourth supply units 111, 113, 115, and 117 may unwind each wound base material to supply the base material to the winding device 140 for the secondary battery through the transfer rollers 121, 123, 125, and 127, respectively. Each base material may be transferred to the winding device 140 to provide a stack (hereinafter referred to as an electrode plate stack) of the first separator 32 and the second separator 34 and the positive electrode plate 10 and the negative electrode plate 20. The state in which the winding of the electrode plate stack is completed may be defined as the electrode assembly 70.

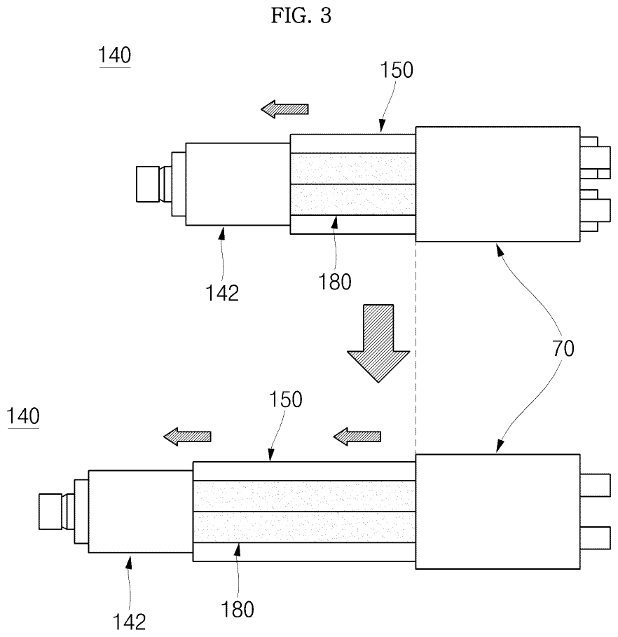

FIG. 2 is a plan view of a winding device 140 for a secondary battery according to embodiments of the present disclosure. FIG. 3 is a plan view showing a core 150 and an electrode assembly 70 separated from each other according to embodiments of the present disclosure. As shown in FIGS. 2 and 3, the winding device 140 may include a rotating part 142 connected to a separate driving part, and the core 150 detachably coupled to the rotating part 142.

The rotating part 142 may be provided as, for example, a mandrel. Referring to FIG. 2, one side of the rotating part 142 may be mechanically connected to the separate driving part, and the other side of the rotating part 142 may be connected to the core 150. The rotating part 142 may rotate the coil 150 to wind the electrode assembly 70 in the form of a jelly roll.

According to some embodiments, the core 150 may wind the electrode assembly 70 including the positive electrode plate 10, the negative electrode plate 20, and the separator 30 and may be transformed into various shapes and be provided with a flat portion and an inclined portion. The winding core 150 may be a central mechanism for winding the electrode assembly 70 and may be mounted on the rotating part 142 and disposed so that structures having the same shape are symmetrically spaced a predetermined interval from each other. A structure at one side of the core 150 may be defined as a first core 160, and a structure at the other side may be defined as a second core 170.

Referring to FIG. 3, after the electrode assembly 70 is wound into the jelly-roll shape, and the rotation of the rotating part 142 may stop. The rotating part 142 may be retracted in a direction of the arrow shown in FIG. 3 so that the electrode assembly 70 is unwound from the core 150.

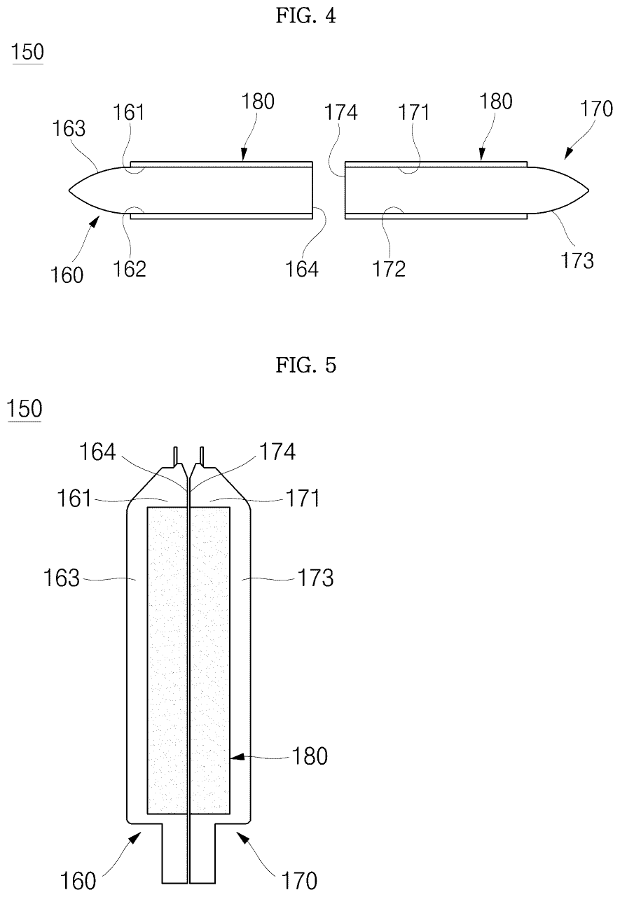

FIG. 4 is a side view of the core 150 and an antistatic part 180 according to embodiments of the present disclosure. FIG. 5 is a plan view of the core 150 and the antistatic part 180 according to embodiments of the present disclosure. As shown in FIGS. 4 and 5, the first core 160 and the second core 170 may extend in a longitudinal direction, and an end of each core 150 may be provided in the form of a straight line and directed toward a center of rotation. An opposite end may have a shape in which a width thereof gradually decreases as it extends outward, and a cross-sectional shape in a width direction may be similar to a bullet.

The core 150 may have a smooth geometry without a groove or slit in a surface thereof to minimize friction and electrostatic attraction with the electrode assembly 70. The first core 160 may include a first front surface 161 defining a plane at an upper side, a first rear surface 162 defining a plane at a lower side, and a first inclined portion 163 and a first side portion 164, which are provided in the form of a wedge connecting the two planes to each other. An antistatic part 180 may be installed on each of the first front surface 161 and the first rear surface 162 and may not be installed on the first inclined portion 163 and the first side portion 164. In this manner, winding defects of the electrode assembly 70 wound outside the core 150 may be prevented if antistatic part 180 is not properly installed.

The second core 170 may extend in a longitudinal direction facing the first core 160. The second core 170 may include a second front surface 171, a second rear surface 172, a second inclined portion 173, and a second side portion 174. An antistatic part 180 may be installed on each of the second front surface 171 and the second rear surface 172. The antistatic part 180 may not be installed on the second inclined portion 173 and the second side portion 174.

The antistatic part 180 may be installed on the flat portion of the core 150 to prevent static electricity from being generated between the core 150 and the electrode assembly 70. The antistatic part 180 may have various geometries and may adhere or be fixed in the form of a tape to the outside of the core 150. In some embodiments, the antistatic part 180 may be installed on at least one of the first front surface 161, the first rear surface 162, the second front surface 171, or the second rear surface 172, and may be installed on the plane of the core 150 to suppress the generation of the static electricity that may occur if in contact with the electrode assembly 70. In some embodiments, the antistatic part 180 may extend in the longitudinal direction of the core 150 and may be provided in a rectangular shape. In this manner, the antistatic part 180 may be effectively attached to the plane of the core 150 to provide stable electrical characteristics during the winding process of the electrode assembly 70.

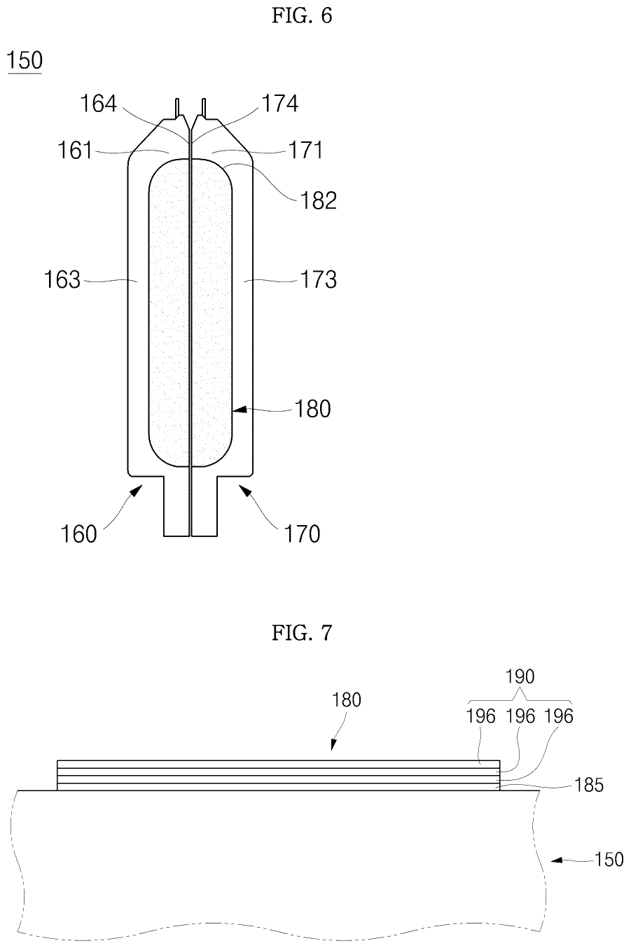

FIG. 6 is a plan view showing a curved portion 182 provided on the antistatic part according to embodiments of the present disclosure. As shown in FIG. 6, in the antistatic part 180, at least one edge of edges in a substantially rectangular geometry, may be curved. In this manner, if the core 150 is separated from the electrode assembly 70, damage may be prevented by minimizing friction between the antistatic part 180 and the electrode assembly 70. In some embodiments, the antistatic part 180 may be provided in a rectangular shape, and each edge may be provided in a curved shape. The curving may reduce a contact area with the electrode assembly 70 to reduce possibility of the generation of the static electricity.

FIG. 7 is a cross-sectional view showing the antistatic part 180 installed outside the core 150 according to embodiments of the present disclosure. As shown in FIG. 7, the antistatic part 180 may have a plurality of layers. The antistatic part 180 may include an adhesive layer 185, a conductive layer 192, an insulating layer 194, and an antistatic layer 196. The adhesive layer 185 may be a layer for fixing the antistatic part 180 to the core 150 and may stably fix the antistatic part 180 using a high-strength adhesive.

The antistatic layer 190 may be a layer designed to effectively prevent the static electricity and may include a fluoropolymer such as polytetrafluoroethylene (e.g., Teflon®). In some embodiments, the antistatic layer 190 may be provided by mixing nanomaterials into a fluoropolymer such as polytetrafluoroethylene (e.g., Teflon®). The antistatic layer 190 may be provided as a single layer or may be provided as a plurality of layer as necessary. If the antistatic layer 190 is provided as the plurality of layers, the antistatic layer 190 may include a conductive layer 192, an insulating layer 194, and an antistatic layer 196, and this configuration may suppress the generation of the static electricity and improve stability of the electrode assembly 70.

In some embodiments, the conductive layer 192 may include at least one of silver nanoparticles, graphene, or carbon nanotubes. The conductive layer 192 may be stacked continuously on the adhesive layer 185 and quickly disperses charges accumulated in the electrode assembly 70 to prevent the static electricity from being accumulated.

In some embodiments, the insulating layer 194 may include at least one of a fluoropolymer such as polytetrafluoroethylene (e.g., Teflon®), polyimide, or silicone rubber. The insulating layer 194 may be stacked continuously on the conductive layer 192 and may prevent current from flowing into the electrode assembly 70 by providing electrical insulation.

In some embodiments, the antistatic layer 196 may include at least one of polymer-based antistatic agents, conductive polymers, or metal oxide nanoparticles. The antistatic layer 196 may be stacked outside the insulating layer 194 and prevent the static electricity from being generated, thereby improving stability between the electrode assembly 70 and the core 150.

The antistatic part 180 may be provided as a nano composite a fluoropolymer such as polytetrafluoroethylene (e.g., Teflon®) tape. The nano composite fluoropolymer tape may be a tape manufactured by mixing nanomaterials into a fluoropolymer such as polytetrafluoroethylene (e.g., Teflon®) and may serve to prevent the static electricity that may occur if in contact with the electrode assembly 70 from being generated. The tape mixed with nanomaterials may improve conductivity, reduce electrostatic attraction, and enable stable separation and winding of the electrode assembly 70. In some embodiments, graphene or carbon nanotubes may be used as nanomaterials mixed into a fluoropolymer such as polytetrafluoroethylene (e.g., Teflon®). In some embodiments, the nano composite tape may be made of a fluoropolymer such as polytetrafluoroethylene (e.g., Teflon®) mixed with nanomaterials, and the mixture may provide excellent properties such as heat resistance and chemical resistance together with antistatic properties. The nano composite tape may effectively disperse the charged charges of the electrode assembly 70 to reduce the electrostatic attraction.

In some embodiments, the nano composite tape may be manufactured by various manufacturing methods, and are not limited to the examples described above, and various technical modifications may be possible.

The antistatic part 180 may be provided as a multilayer fluoropolymer tape. The multilayer fluoropolymer tape may be a tape provided as a plurality of layers and may serve to prevent the static electricity generation from being generated and control conductivity if in contact with the electrode assembly 70. The multilayer structure may optimize characteristics of each layer to reduce the electrostatic attraction and ensure the stability of the electrode assembly 70. In this manner, the tape may sequentially dispose the conductive layer 192, the insulating layer 194, the antistatic layer 196, etc., based on a fluoropolymer such as polytetrafluoroethylene (e.g., Teflon®).

In some embodiments, the conductive layer 192 may effectively disperse the charges by including nanomaterials, the insulating layer 194 may provide electrical insulation, and the antistatic layer 196 may perform the function of suppressing the generation of the static electricity. In some embodiments, the multilayer fluoropolymer tape may effectively reduce the electrostatic attraction between the electrode assembly 70 and the core 150 by combining the layers to perform a unique function.

In some embodiments, the multilayer fluoropolymer tapes may be manufactured by various methods such as laminating and sputtering, but are not limited thereto, and various technical modifications may be possible.

The nano composite fluoropolymer tape and the multilayer structure fluoropolymer tape may solve the limitation of the static electricity between the electrode assembly 70 and the core 150 and improve stability and performance of the secondary battery.

The antistatic part 180 may be installed outside the core 150 using various coating technology.

The antistatic part 180 may be provided through polymer nanocomposite coating. In the polymer nanocomposite coating, nanoparticles may be mixed into a polymer matrix to apply the material for effectively preventing the generation of the static electricity to the outside of the core 150.

The polymer matrix may provide flexibility and durability, and the nanoparticles may provide high conductivity to suppress the generation of the static electricity. In this manner, in the polymer nano composite coating, the electrostatic attraction between the electrode assembly 70 and the core 150 may be reduced to enable the stable separation and winding of the electrode assembly 70.

In some embodiments, carbon nanotubes or graphene may be used as nanoparticles, and the nanoparticles may greatly improve the conductivity of the polymer nano composite coating. The polymer matrix may serve to minimize static electricity accumulation while preventing physical damage to the electrode assembly 70.

In some embodiments, the polymer nano composite coating may be applied in various manners such as spray coating and roll coating, and various technical modifications may be possible.

The antistatic part 180 may be provided through plasma chemical vapor deposition (CVD). Plasma enhanced chemical vapor deposition (PECVD) may be utilized to deposit polymer materials using plasma and thus may form very thin and uniform polymer coating. The PECVD process may enable the stable coating even at elevated temperatures and maximize antistatic performance.

The coating performed through the plasma chemical vapor deposition may be formed on a surface of the core 150 at a uniform thickness, thereby reducing the electrostatic attraction that may occur if in contact with the electrode assembly 70. The polymer coating performed through the PECVD process may provide high adhesion and durability, thereby improving the stability of the electrode assembly 70.

In some embodiments, the PECVD process may be applied to various polymer materials and be used in combination with other processes as necessary.

The antistatic part 180 may be provided through multilayer coating. The multilayer coating may be a method of maximizing the antistatic performance by sequentially depositing multiple layers made of different materials. The first layer may be made of a conductive material to dissipate the static electricity, the second layer may be made of an insulating polymer to provide the electrical insulation, and the third layer may be made of an antistatic polymer to suppress the generation of the static electricity.

In the multilayer structure coating, each layer may perform the unique function to significantly reduce the electrostatic attraction between the electrode assembly 70 and the core 150 and ensure the stability and performance of the electrode assembly 70. The multilayer structure may improve the durability of the coating and prevent long-term performance degradation of the electrode assembly 70.

In some embodiments, the multilayer structure coating may be performed by various deposition methods such as sputtering and laminating, and a material and thickness of each layer may be adjusted as necessary.

The polymer nano composite coating, the PECVD process, and the multilayer structure coating may maximize the antistatic performance by utilizing their respective characteristics, and effectively solve the limitation of the static electricity between the electrode assembly 70 and the core 150.

In some embodiments, the antistatic part 180 may include an antistatic film. The antistatic film according to the present disclosure may have the characteristic of having an antistatic function itself and not requiring a separate coating process and may be easily applied by wrapping the antistatic film on the outside of the core 150. The ease of application of the film may greatly improve productivity. The film may be wrapped directly on the surface of the core 150 to effectively prevent the static electricity from being generated and ensure the stability of the electrode assembly 70.

In some embodiments, the antistatic film may be designed with the multilayer structure. The multilayer structure may allow each layer to perform its own unique function. The multilayer film may prevent the static electricity accumulation and minimize the friction between the electrode assembly 70 and the core 150, thereby preventing damage.

In some embodiments, the film may include conductive nanomaterials. The antistatic performance may be significantly improved by enhancing the conductivity of the film by incorporating the conductive nanomaterials, such as graphene or carbon nanotubes, into the film. The conductive nanomaterials may improve the electrical properties of the film to support safe winding and separation of the electrode assembly 70.

In some embodiments, the antistatic film may include hybrid materials. The hybrid materials can be made by a combination of various polymers and nanomaterials and simultaneously may improve the durability and antistatic performance of the film. The hybrid material film may be stably attached to the surface of the core 150 to improve the reliability of the electrode assembly 70 as well as maintaining the long-term performance.

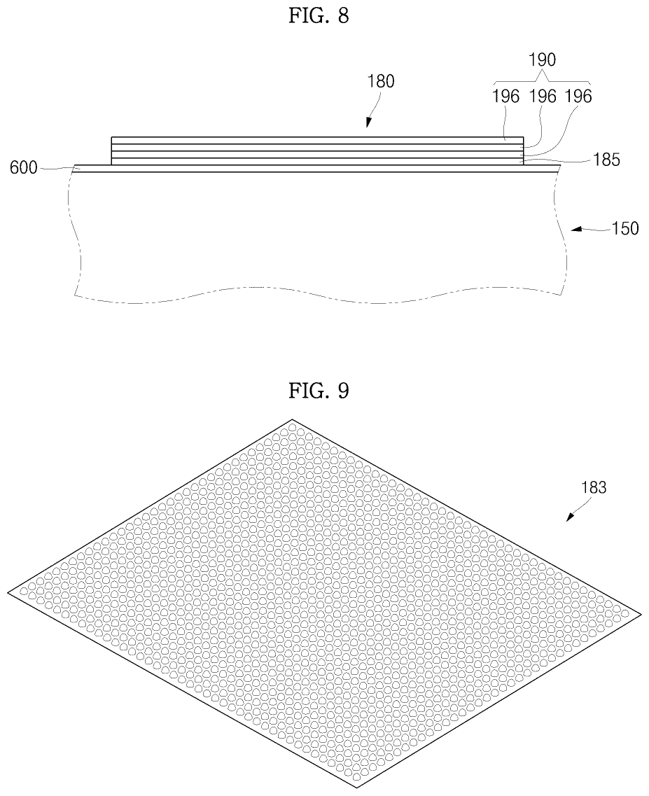

FIG. 8 is a cross-sectional view showing a coating layer 600 disposed between the core 150 and the antistatic part 180 according to embodiments of the present disclosure. As shown in FIG. 8, the coating layer 600 may be applied on the outside of the core 150 to reduce the friction with the electrode assembly 70 and prevent the generation of the static electricity. The coating layer 600 may reduce the electrostatic attraction between the core 150 and the electrode assembly 70 to facilitate the separation of the core 150 and preventing the detachment or damage to the electrode assembly 70. In this manner, the coating layer 600 may be disposed on the surface of the core 150.

In some embodiments, the coating layer 600 having low electrical conductivity may be disposed on the surface of the core 150. In some embodiments, the coating layer 600 may include perfluoroalkoxy (PFA) which has excellent heat resistance and chemical resistance. In some embodiments, conductive carbon may be mixed into the coating layer 600. The conductive carbon may assist movement of electrostatic charges charged in the electrode assembly 70, thereby reducing the electrostatic attraction.

In some embodiments, the coating layer 600 may be formed by a coating method such as electrostatic painting, anti-finger coating (AF coating), or dip coating, but is not limited to these methods, and various coating technologies may be applied.

FIG. 9 shows an antistatic part 180 according to embodiments of the present disclosure. As shown in FIG. 9, the surface of the antistatic part 180 may include an embossing pattern. The embossed structure may reduce a contact area between the antistatic part 180 and the electrode assembly 70, thereby reducing friction and suppressing generation of static electricity. In some embodiments, the embossed surface may reduce possibility of damage to the electrode assembly 70 and improves antistatic performance.

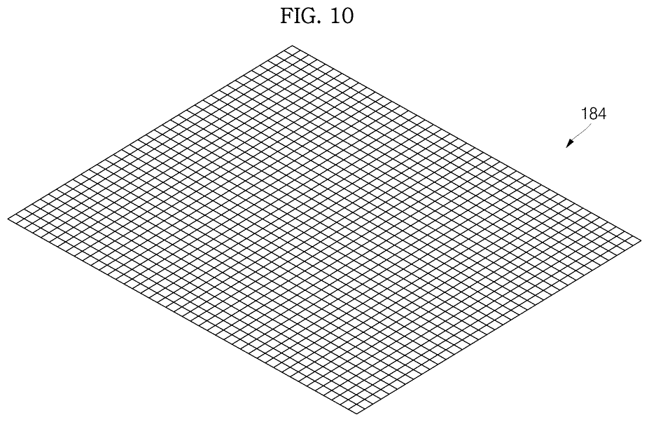

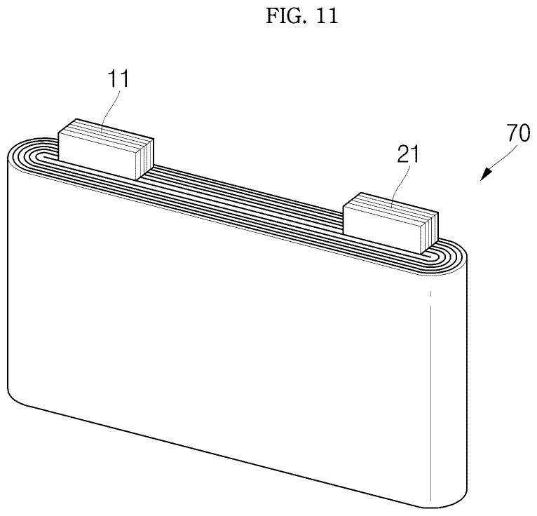

FIG. 10 shows an antistatic part 180 according to embodiments of the present disclosure. As shown in FIG. 10, the surface of the antistatic part 180 may include a grid pattern. The grid-patterned structure may reduce a contact area between the antistatic part 180 and the electrode assembly 70 to prevent static electricity accumulation and enable stable separation of the electrode assembly 70. The grid-patterned surface may also disperse minute static electricity that may occur during a winding process, thereby improving quality and reliability of the electrode assembly 70.

FIG. 11 shows an electrode assembly 70 wound by a winding device 140 for a secondary battery according to embodiments of the present disclosure. As shown in FIGS. 1 and 11, the electrode assembly 70 wound by the winding device 140 for the secondary battery may have a positive electrode base material tab 11 and a negative electrode base material tab 21 protruding in the same direction relative to the winding axis. The positive electrode base material tab 11 and the negative electrode base material tab 21 may be referred to as a multi-tap. Each of the positive electrode base material tab 11 and the negative electrode base material tab 21 may serve as a current collector of the electrode assembly 70.

Advantageously, the present disclosure relates to the winding device 140 for the secondary battery for solving the limitation of the shape instability and the winding defects of the electrode assembly 70 that may occur if the core 150 is separated from the electrode assembly 70 of the secondary battery. The antistatic part 180 may be installed on the surface of the core 150 to reduce the frictional force and the electrostatic attraction between the electrode assembly 70 and the core 150, thereby enabling the stable separation and winding without damage to the electrode assembly 70. In this manner, the shape of the electrode assembly 70 may be maintained, the winding defects may be reduced, and the performance and stability of the secondary battery may be improved.

As the positive electrode active material, a compound capable of reversibly intercalating/deintercalating lithium (e.g., a lithiated intercalation compound) may be used. In some embodiments, at least one of a composite oxide of lithium and a metal selected from cobalt, manganese, nickel, and combinations thereof may be used.

The composite oxide may include a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

In some embodiments, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may include aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may include a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may include silicon, a silicon-carbon composite, SiOx (0<x<2), a Si-based alloy, or a combination thereof.

The silicon-carbon composite may include a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

In some embodiments, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may include a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

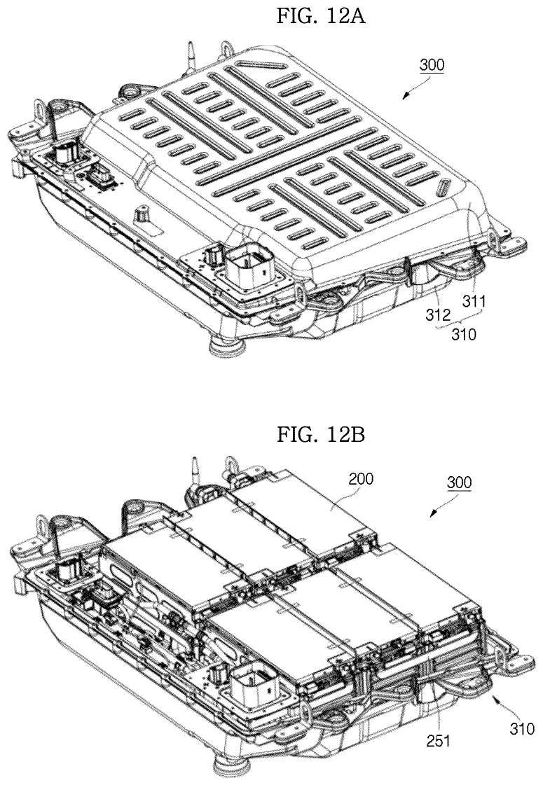

The batteries according to the above-described embodiments may be used to manufacture a battery pack. FIGS. 12A and 12B are perspective views of a battery pack including a secondary battery according to embodiments of the present disclosure. Referring to FIGS. 12A and 12B, the battery pack 300 may include a plurality of battery modules 200 and a housing 310 to accommodate the plurality of battery modules 200. In some embodiments, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

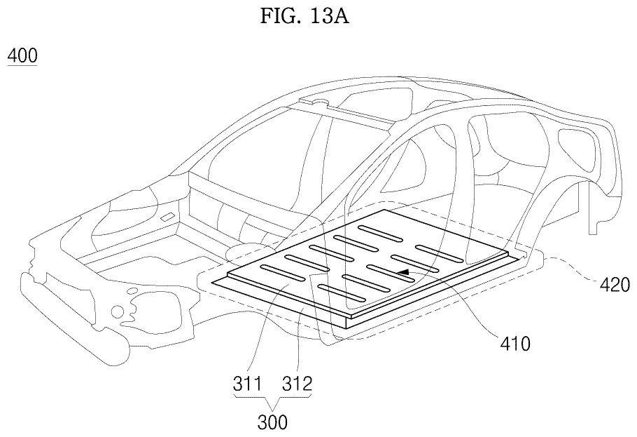

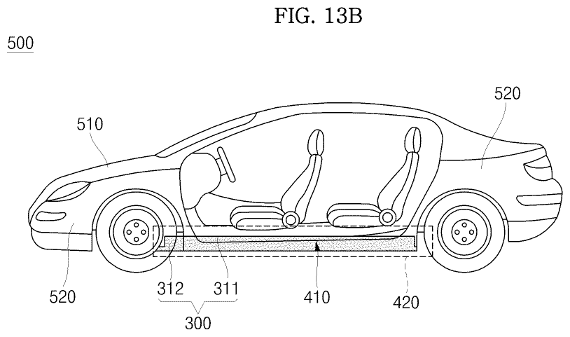

FIG. 13A is a perspective view showing a vehicle 400 including a battery pack 300 including a secondary battery according to embodiments of the present disclosure. FIG. 13B is a side view showing a vehicle 500 including a battery pack 300including a secondary battery according to embodiments of the present disclosure.

In FIG. 13A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 13B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to the present disclosure, the limitation of the unstable shape of the electrode assembly, which may occur if the core is separated from the electrode assembly of the electrode assembly of the secondary battery, may be effectively solved.

According to the present disclosure, the surface properties of the core may be improved to reduce the winding defects that may occur during the winding process of the electrode assembly, thereby improving the production efficiency.

However, the effects achievable through the present invention are not limited to those described above, and other technical effects not mentioned can be clearly understood by those skilled in the art from the description of the invention provided above.

Although a few embodiments of the present disclosure have been shown and described, it would be appreciated by those skilled in the art that various changes and modifications may be made in this embodiment without departing from the principles and spirit of the disclosure.

What is claimed is:

1. A winding device for a secondary battery, comprising:
a core comprising a flat portion and an inclined portion, the core configured to wind an electrode assembly, the electrode assembly comprising a positive electrode plate, a negative electrode plate, and a separator; and
an antistatic part disposed on the flat portion,
wherein static electricity is prevented from being generated between the core and the electrode assembly.

2. The winding device as claimed in claim 1, wherein the core comprises:
a first core extending in a longitudinal direction; and
a second core extending in the longitudinal direction and facing the first core.

3. The winding device as claimed in claim 2, wherein the first core comprises:
a first front surface defining a plane at an upper side of the first core;
a first rear surface defining a plane at a lower side of the first core;
a first inclined portion connecting the first front surface to one side of the first rear surface in a lateral direction; and
a first side portion connecting the first front surface to the other side of the first rear surface in the lateral direction.

4. The winding device as claimed in claim 3, wherein the second core comprises:
a second front surface defining a plane at an upper side of the second core;
a second rear surface defining a plane at a lower side of the second core;
a second inclined portion connecting the second front surface to one side of the second rear surface in a lateral direction; and
a second side portion connecting the second front surface to the other side of the second rear surface in the lateral direction.

5. The winding device as claimed in claim 4, wherein the antistatic part is disposed on at least one selected from the first front surface, the first rear surface, the second front surface, and the second rear surface.

6. The winding device as claimed in claim 4, wherein the antistatic part is disposed on the first front surface, the first rear surface, the second front surface, and the second rear surface.

7. The winding device as claimed in claim 1, wherein the antistatic part comprises a tape attached to an exterior of the core and is disposed on each of planes on front and/or rear surfaces of the core.

8. The winding device as claimed in claim 7, wherein the antistatic part extends in a longitudinal direction of the core and has a substantially rectangular geometry.

9. The winding device as claimed in claim 8, wherein, in the antistatic part, at least one edge of edges in the substantially rectangular geometry is curved.

10. The winding device as claimed in claim 1, wherein the antistatic part comprises:
an antistatic layer comprising a fluoropolymer; and
an adhesive layer configured to fix the antistatic layer to the core.

11. The winding device as claimed in claim 10, wherein nanomaterials are mixed into the fluoropolymer.

12. A winding device for a secondary battery, comprising:
a core comprising a flat portion and an inclined portion, the core configured to wind an electrode assembly, the electrode assembly comprising a positive electrode plate, a negative electrode plate, and a separator;
a coating layer applied to an exterior of the core; and
an antistatic part applied to the exterior of the coating layer,
wherein static electricity is prevented from being generated between the core and the electrode assembly.

13. The winding device as claimed in claim 12, wherein the antistatic part extends in a longitudinal direction of the core and has a substantially rectangular geometry.

14. The winding device as claimed in claim 13, wherein, in the antistatic part, at least one edge of edges in the substantially rectangular geometry is curved.

15. The winding device as claimed in claim 12, wherein the antistatic part comprises:
an antistatic layer comprising a fluoropolymer; and
an adhesive layer configured to fix the antistatic layer to the core.

16. The winding device as claimed in claim 15, wherein the antistatic layer comprises:
a conductive layer disposed on and in contact with the adhesive layer, the conductive layer;
an insulating layer disposed on and in contact with the conductive layer; and
an antistatic layer disposed on and in contact with an exterior of the insulating layer.

17. The winding device as claimed in claim 16, wherein the conductive layer comprises silver nanoparticles, graphene, or carbon nanotubes.

18. The winding device as claimed in claim 16, wherein the insulating layer comprises a fluoropolymer, a polyimide, or a silicone rubber.

19. The winding device as claimed in claim 16, wherein the antistatic layer comprises a polymer-based antistatic agent, a conductive polymer, or metal oxide nanoparticles.

20. The winding device as claimed in claim 12, wherein an embossing or grid pattern is disposed on a surface of the antistatic part.
